(19) United States
(12) Patent Application Publication
(10) Pub. No.: US 2011/0057751 A1
(43) Pub. Date: Mar. 10, 2011

(54) SWITCHING DEVICE

(76) Inventors: Wolfgang Feil, Schwandorf (DE); Jörg Hassel, Erlangen (DE)

(21) Appl. No.: 12/991,145

(22) PCT Filed: May 6, 2008
(86) PCT No.: PCT/EP2008/003628

§ 371 Date: Nov. 5, 2010

(51) Int. Cl. H01H 36/00

(52) U.S. Cl. 335/205

(57) ABSTRACT

A switching device includes a movable contact for opening and closing a circuit, and a magnetic shape memory alloy for driving the movable contact. In at least one embodiment, the switching device includes at least one actuator that activates the holding mode of the switching device.

### PRIORITY STATEMENT

This application is the national phase under 35 U.S.C. § 371 of PCT International Application No. PCT/EP2008/003628 which has an International filing date of May 6, 2008, which designates the United States of America, the entire contents of which are hereby incorporated herein by reference.

### FIELD

At least one embodiment of the invention generally relates to a switching device with a movable contact for closing and opening a circuit and with a magnetic shape memory alloy, by which the position of the movable contact can be changed.

### BACKGROUND

A switching device is known from WO 2007/057030 A1, in which the tripping armature of the drive for tripping in the event of short-circuit currents comprises a ferromagnetic shape memory alloy.

Secondly, it is known that certain shape memory alloys are magnetically sensitive and are subject to a change in length when a magnetic field passes through them. The force generated in the event of a change in length can in principle be used as a drive force. The known magnetic shape memory alloys display a technically usable response in terms of change in length only in strong magnetic fields of at least 0.5 tesla. In technical applications such as the switching device proposed here, high drive currents with a correspondingly high energy consumption need to be avoided.

### SUMMARY

In at least one embodiment of the invention, a switching device includes a magnetic shape memory alloy, sensitive to magnetic fields, which only requires a small current consumption for inducing a magnetic field in the shape memory alloy for the holding mode.

In at least one embodiment, a movably mounted magnet is provided, it being possible to change a magnetic field acting on the magnetic shape memory alloy for closing and opening the circuit by virtue of changing the position of said magnet. This makes it possible in a simple manner to control the drive force emanating from the shape memory alloy and acting on the movable contact.

Advantageous developments of the invention are given in the dependent claims.

It is particularly advantageous if the magnet is the form of a ferromagnet.

It is furthermore advantageous if a drive is provided, by which the position of the magnet can be changed.

In addition, it is advantageous if a plate is provided which passes on the drive force of the shape memory alloy to the movable contact.

If the plate has a high modulus of elasticity, it is ensured that a low pressure is applied uniformly to the shape memory alloy.

Advantageously, a plate-shaped component part which has a low thermal conductivity and a low radiation absorption is provided between the movable contact and the shape memory alloy, which brings about thermal protection with respect to switching energy converted into heat.

### BRIEF DESCRIPTION OF THE DRAWINGS

Example embodiments will be explained in more detail below with reference to a drawing, in which:

FIG. 1 shows a schematic illustration of a switching device according to the invention with a shape memory alloy which is sensitive to magnetic fields and a technical device, which is separate from said switching device, for controlling a magnetic field passing through the shape memory alloy,

FIG. 2 shows an example embodiment of the switching device according to the invention as shown in FIG. 1 in the OFF position with a movably mounted magnet, and

FIG. 3 shows an example embodiment of the switching device according to the invention as shown in FIG. 1 in the ON position with a movably mounted magnet.

### DETAILED DESCRIPTION OF THE EXAMPLE EMBODIMENTS

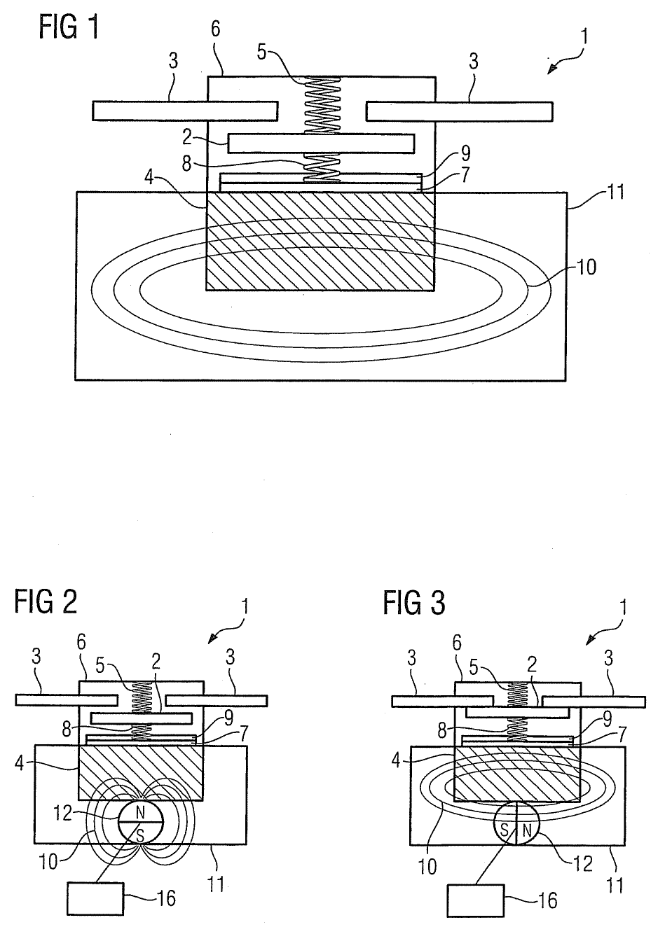

FIG. 1 shows a schematic of a switching device 1 according to an embodiment of the invention with a movable contact 2 and two fixed contacts 3 for switching on and off a circuit. The switching device 1 has a drive which is sensitive to magnetic fields and comprises a magnetic shape memory alloy 4 which exerts a drive force for closing the circuit on the movable contact 2. A pressure is applied to the drive in the rest position by means of a spring 5, which is supported on the housing 6, the pressure ensuring the operation of the drive in two directions. For the optimum operation of the drive which is sensitive to magnetic fields, it is ensured with the aid of a plate 7 that a low pressure is applied uniformly to the shape memory alloy 4. This can be achieved by the plate 7 with a high modulus of elasticity, which plate, insofar as is technically possible, covers the surface of the shape memory alloy 4 in the direction of the contacts 2, 3. The plate 7 is arranged between the spring 5 and the shape memory alloy 4 and drives the movable contact 2 via a spring 8. The shape memory alloy 4 is protected if possible from heating by switching energy converted into heat by means of a plate-shaped component part 9 with a low thermal conductivity and poor radiation absorption.

The controlling magnetic field 10 in the shape memory alloy 4 is induced with the aid of a technical device 11. By virtue of the controlling magnetic field in the shape memory alloy 4, the shape memory alloy 4 experiences an extension of length and therefore causes the movable contact 2 to close with the fixed contact 3. This takes place via the spring 8, which ensures the required contact force for guiding the current.

In order to make full use of the drive with the magnetic shape memory alloy 4, the magnetic field needs to pass through said shape memory alloy as homogeneously as possible with at the same time a high field strength. This can be achieved by a suitable arrangement of ferromagnetic component parts between the technical device 11 for inducing the magnetic excitation and the magnetic shape memory alloy 4.

No coil with an iron core is provided which is used for exclusively inducing the magnetic field at the level which is required for the necessary change in length of the shape memory alloy 4 in order thus to bring about the holding mode. For this purpose, permanently high currents would be required which would result in an unacceptably high current consumption, which is intended to be avoided by an embodiment of the present invention.

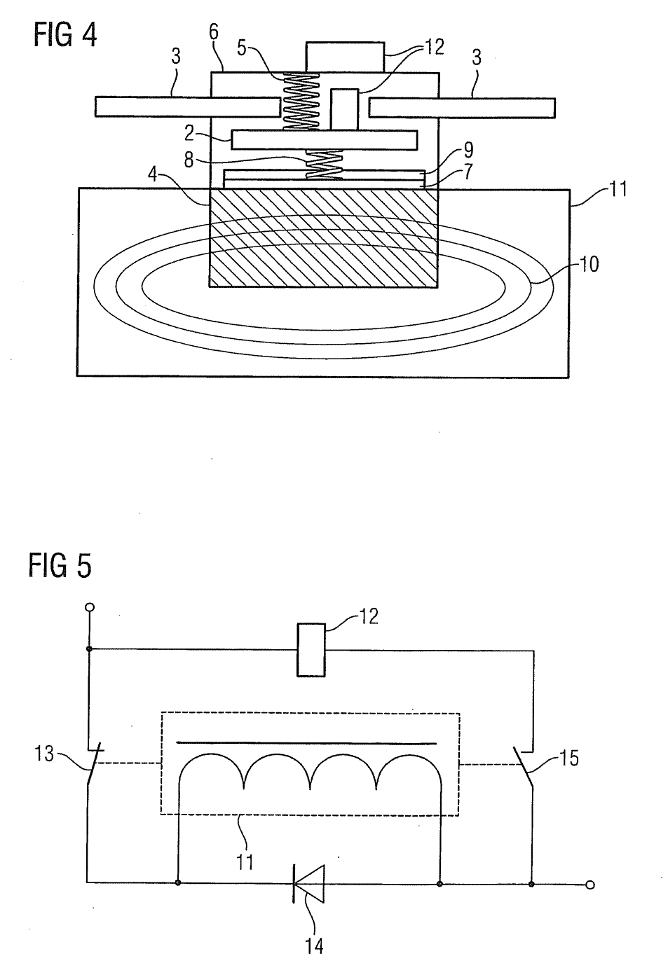

Instead, in the example embodiment below shown in FIGS. 2 and 3, an actuator 12, in this case a movably mounted, ferromagnetic permanent magnet, is used which has a position which can be varied by a drive 16.

In the OFF contact position shown in FIG. 2, the permanent magnet is located in the position in which only a fraction of the magnetic field of the permanent magnet passes through the shape memory alloy 4. For switching on, i.e. closing the switching device, a rotation of the permanent magnet through 90° is initiated with the aid of the drive 16.

As a result, the shape memory alloy 4 is magnetized by the entire magnetic field of the permanent magnet and causes the movable contact 2 to close with the fixed contacts 3 shown in FIG. 3. The movable contact 2 drops away again if the permanent magnet is brought into the OFF position actively by the rotary drive 16 or with the aid of an energy store which brings the magnet into the OFF position in the event of a drop in the control voltage. In both cases, the contact position shown in FIG. 2 is present again.

The arrangement explained in the example embodiments make it possible to decrease the physical size of a contactor drive. Owing to the relatively high mechanical prestress, it is no longer necessary to reserve a large proportion of the attraction path for a safety gap for ensuring vibration and shock resistance, as is the case at present in conventional relays and contactors. This keeps the physical volume of the shape memory alloy 4 low. A parallelepiped of a shape memory alloy 4 with a basic area of 2 cm² and a height of 8 cm is sufficient, with a high degree of reliability, for ensuring a switching path of 4 mm with a force of 100 N applied. The high force of the shape memory alloy makes it possible to further enlarge the displacement path via levers.

The technical solution given in the example embodiment for inducing the controlling magnetic field likewise has smaller dimensions than a conventional reluctance drive with comparable power.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A switching device comprising:
a movable contact to close and open a circuit;
a magnetic shape memory alloy, by which a position of the movable contact is changeable; and
a movably mounted magnet, a magnetic field acting on the magnetic shape memory alloy being changeable to close and open the circuit by virtue of changing a position of said movably mounted magnet.

2. The switching device as claimed in claim 1, wherein the movably mounted magnet is the form of a ferromagnet.

3. The switching device as claimed in claim 1, wherein a drive is provided, by virtue of which the position of the movably mounted magnet is alterable.

4. The switching device as claimed in 1, wherein a plate is provided which passes on the drive force of the shape memory alloy to the movable contact.

5. The switching device as claimed in claim 4, wherein the plate has a high modulus of elasticity.

6. The switching device as claimed in claim 1, wherein a plate-shaped component part, which includes a low thermal conductivity, is provided between the movable contact and the shape memory alloy.

7. The switching device as claimed in claims 1, wherein the plate-shaped component part includes a low radiation absorption.

8-11. (canceled)

12. The switching device as claimed in claim 2, wherein a drive is provided, by virtue of which the position of the movably mounted magnet is alterable.

13. The switching device as claimed in 2, wherein a plate is provided which passes on the drive force of the shape memory alloy to the movable contact.

14. The switching device as claimed in claim 13, wherein the plate has a high modulus of elasticity.

15. The switching device as claimed in claim 2, wherein a plate-shaped component part, which includes a low thermal conductivity, is provided between the movable contact and the shape memory alloy.

16. The switching device as claimed in claim 2, wherein the plate-shaped component part includes a low radiation absorption.
